(19) United States
(12) Patent Application Publication
(10) Pub. No.: US 2026/0057331 A1
(43) Pub. Date: Feb. 26, 2026

(54) MULTI-AGENT SIMULATION SYSTEM AND METHOD

(71) Applicant: Royal Bank of Canada, Toronto (CA)

(72) Inventors: Timothy Zheng, Markham (CA); Hisham Ladha, Montreal (CA); Masha Solaja, Toronto (CA); Andrew Chen, Toronto (CA)

(21) Appl. No.: 19/306,374

(22) Filed: Aug. 21, 2025

Related U.S. Application Data
(60) Provisional application No. 63/685,613, filed on Aug. 21, 2024.

(51) Int. Cl. G06Q 10/067; G06F 16/9532

(52) U.S. Cl. CPC G06Q 10/0674; G06F 16/9532

(57) ABSTRACT

Methods, systems, and techniques for performing a multi-agent simulation. A first large language model (“LLM”) is prompted to act as a sales agent of a financial institution to generate a sales pitch. A second LLM is prompted to act as a client of the financial institution to engage in a conversation with the first LLM in response to the sales pitch. A third LLM is prompted to act as a judge to generate and output a score of the conversation between the first and second LLMs. The score is saved and/or output to a display. The multi-agent simulation is used to create a digital twin of an actual conversation between the sales agent and client.

### CROSS-REFERENCE TO RELATED APPLICATIONS

This application claims priority to and benefit of U.S. patent application No. 63/685,613, filed on Aug. 21, 2024, and entitled “MULTI-AGENT SIMULATION SYSTEM AND METHOD”, the entirety of which is hereby incorporated by reference herein.

### TECHNICAL FIELD

The present disclosure is directed at methods, systems, and techniques for simulating a system comprising multiple intelligent agents.

### BACKGROUND

A “digital twin” is a virtual representation of a real-world physical asset or system. A digital twin can accordingly be used to simulate the operation of the physical asset or system, and to make appropriate predictions from that simulation. One way in which to create a digital twin is to use a “multi-agent system”, with different agents of the multi-agent system used to mimic different persons or objects of the physical asset or system.

### SUMMARY

According to a first aspect, there is provided a multi-agent simulation method, comprising: using a first large language model (“LLM”) prompted to act as a sales agent of a financial institution to generate a sales pitch; using a second LLM prompted to act as a client of the financial institution to engage in a conversation with the first LLM in response to the sales pitch; using a third LLM prompted to act a judge to generate and output a score of the conversation between the first and second LLMs; and outputting the score to a file or display.

The multi-agent simulation method may further comprise providing a system prompt to the second LLM prior to the second LLM engaging in the conversation with the first LLM, and the system prompt may comprise at least one of facts describing the client or instructions regarding how to converse with the first LLM.

Generating the system prompt may comprise using the fourth LLM to query at least one knowledge source about the client.

The at least one knowledge source may comprise a database of the financial institution storing information about the client.

The at least one knowledge source may be external to the financial institution.

The at least one knowledge source may be a world wide web search engine.

The fourth LLM may repeatedly query the world wide web search engine.

The third LLM may generate multiple scores of the conversation, and the method may further comprise averaging the multiple scores to result in an averaged score of the conversation.

The multiple scores may be respectively generated over multiple scoring runs each associated with scoring reasons, and the scoring reasons associated with the one of the multiple scores closest to the averaged score may be provided as scoring reasons for the average score.

The multi-agent simulation method may further comprise providing the system prompt to a constructor used to create the second LLM.

The multi-agent simulation method may further comprise providing materials comprising any one or more of sales mandates, financial institution policies, and product summaries to a context window of the first LLM prior to the conversation, and the materials may be provided to a constructor used to create the first LLM.

The first through third LLMs may all inherit functionality of a shared LLM model.

According to another aspect, there is provided a multi-agent simulation method, comprising: using a first large language model (“LLM”) prompted to act as a sales agent of a financial institution to generate a sales pitch; using a second LLM prompted to act as a client of the financial institution to generate a response to the sales pitch; using a third LLM prompted to act a judge to generate and output a score of the response; and outputting the score to a file or display.

The multi-agent simulation method may further comprise: initializing each of the first, second, and third LLM with a respective system prompt defining, for a respective LLM, a role, a background, a personality, one or more rules, or combinations thereof.

The first LLM may be prompted to sell a product, the second LLM may be prompted to indicate a level of interest in the product in response to the sales pitch, and the third LLM may be prompted to analyze the response to generate the score based on the level of interest.

The first LLM may be initialized with a prompt comprising information on the product and/or one or more policies of the institution.

The second LLM may be initialized with a prompt comprising a summary of information corresponding to the client.

The summary may be generated using a fourth LLM by querying at least one knowledge source about the client; and the fourth LLM may be initialized with a prompt comprising a name of the client.

The multi-agent simulation method may further comprise: querying a summary database for the summary; and generating the summary using the fourth LLM if the summary for the client is not present in the summary database.

The at least one knowledge source may comprise a database of the financial institution storing information on the client; and the summary may comprise past interactions with the client and/or a portfolio of the client.

The at least one knowledge source may be external to the financial institution; and the querying may comprises a world wide web search comprising: splitting a query string into first chunks; generating first embeddings from the first chunks; generating first vectors from the first embeddings; and querying a world wide web search engine using the first vectors.

The querying may utilize retrieval augmented generation.

The fourth LLM may perform the world wide web search by iteratively querying the world wide web search engine a first predetermined number of times; and the fourth LLM may generate each subsequent query based on results of previous queries.

One or more queries may correspond to one or more predefined questions.

Generating each subsequent query using the fourth LLM may comprise: splitting query results into second chunks; generating second embeddings from the second chunks; and generating second vectors from the second embeddings for processing by the fourth LLM.

The multi-agent simulation method may further comprise: generating and outputting a reasoning for the score.

The third LLM may generate multiple scores; a number of the multiple scores may be a second predetermined number; the score may be an average of the multiple scores; the multiple scores may be iteratively generated over multiple scoring runs each associated with a respective reasoning, and the reasoning associated with the one of the multiple scores closest to the averaged score may be output as the reasoning for the average score.

The first LLM may generate a plurality of sales pitches using a plurality of LLMs, each configured to generate a respective sales pitch corresponding to a respective product;

The second LLM may generate a plurality of responses corresponding to the plurality of sales pitches; and the third LLM may generate a plurality of scores corresponding to the plurality of sales pitches.

The multi-agent simulation method may further comprise, after using the second LLM to generate the response, iteratively refining the sales pitch by: generating a refined sales pitch by processing the response from the second LLM using the first LLM; and generating an updated response to the refined sales pitch by processing the refined sales pitch using the second LLM, the updated response may be used as the response for generating the refined sales pitch for a subsequent iteration.

The third LLM may generate the score for each iteration based on the refined sales pitch and the updated response, the sales pitch being iteratively refined until the score is above a threshold value; or the sales pitch may be iteratively refined for a third predetermined number of iterations.

An agent class object may be used to initialize each LLM; each of the respective system prompt may be provided to a constructor of the agent class object to initialize each LLM; and a function invoking agent class objects of the first and second LLM may be called to cause the first and second LLMs to interact.

Each LLM may inherit functionality of a shared LLM model and corresponds to a child agent class object of the agent class object.

Each of the respective system prompt may be generated according to a respective template; The respective template may comprise at least one placeholder in addition to the role, the background, the personality, the one or more rules, or combinations thereof; and the at least one placeholder may accept: information on the product and/or one or more policies of the institution for prompting the first LLM; the summary for prompting the second LLM; the response for prompting the third LLM; and the name of the client for prompting the fourth LLM.

According to another aspect, there is provided a system comprising: at least one network interface; at least one processing unit communicatively coupled to the at least one network interface, in which the at least one processing unit is configured to perform any one or more of the above-described methods.

According to another aspect, there is provided at least one non-transitory computer readable medium having stored thereon computer program code that is executable by at least one processor and that, when executed by the at least one processor, causes the at least one processor to perform any one or more of the above described methods.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a network diagram illustrating one architecture used to implement a multi-agent simulation system, according to an example embodiment.

FIG. 2 is a block diagram of a server comprising part of the architecture of FIG. 1.

FIG. 3 is a block diagram of a multi-agent simulation system, according to an example embodiment.

FIG. 4 is an architecture flow diagram of the multi-agent simulation system, according to an example embodiment.

FIG. 5 is a UML class diagram illustrating the classes used in the multi-agent simulation system, according to an example embodiment.

FIG. 6 depicts search logic applied by a researcher agent when searching research materials, according to an example embodiment.

FIG. 7 is a block diagram depicting components downstream of the multi-agent simulation system 300 used to process the outputs thereof, according to an example embodiment.

FIG. 8 is a flow diagram depicting a method of using the multi-agent simulation system, according to an example embodiment.

### DETAILED DESCRIPTION

A multi-agent system (“MAS”) is a system that comprises multiple intelligent agents that each fulfill a particular role. Each agent may be implemented using one or more large language models (each an “LLM”). Collectively, through appropriate prompting and context windows, the different intelligent agents may collectively form a MAS that mimics a real-world environment. Creating a multi-agent system that suitably mimics a real-world problem is technically challenging. Namely, the various LLMs used to implement the multi-agent system need to be appropriately selected and prompted, with suitably large context windows, in order to adequately mimic the real-world environment.

At least some of the embodiments described herein are directed at a multi-agent system that is designed to mimic the sales ecosystem of a financial institution. By creating a virtual world that is a digital twin of that ecosystem, interactions between clients (represented by client agents), researchers (represented by researcher agents), financial institutions (represented by sales agents) and managers (represented by judging/manager agents) can be simulated, and the outcomes analyzed to guide real-world behavior. In at least some embodiments, the interactions can be used to generate and provide product recommendations. Each agent is engineered with and ingests various prompts that helps them output a prediction of expected, real-world behavior. The client agent, for example, is given prompts to help represent goals and needs of actual clients, and comprises information such as current financial products owned by the client and trading history, often available to the financial institution.

In at least some embodiments, these prompts may be enhanced by scraping a data source; the data source may be Internet content, such as data available on the World Wide Web. For example, clients may have websites that provide information such as the client's mission statement, or quarterly/annual financial statements together with related management discussion and analysis. This data may be scraped and used as a client summary that is provided as a prompt to the client agent. Similarly, the financial institution's website may be scraped to obtain information such as revenue targets and used to customize the sales agent's prompts. The sales agent can also be provided with specific goals, such as to create revenue for the financial institution and the client as well as to ensure that the client has a need for potential product offerings.

The client and sales agents interact with each other—they “talk”—in the context of the sales agent attempting to sell the client agent a product, which simulates their interactions in real life. The conversation is recorded and analyzed by the judging agent to gauge the client agent's receptiveness to onboarding/purchasing that product, which can be used to guide real-world interactions. In at least some embodiments, each product may have its own, dedicated sales agent. During the judging agent's deliberation, the judging agent may also consider previous conversations recorded between the sales and client agents and/or real-world salesperson-client interactions to increase accuracy.

In at least some embodiments, the judging agent scores each simulated conversation between a client agent and a sales agent for each product that the client agent may potentially purchase. This allows a real-world individual to take the ranked products and focus on those with the higher scores, thereby leveraging LLMs, and more particularly the context window of LLMs that permits them to maintain all or substantial portions of the conversation between the agents, to better simulate real-world performance between diverse parties with distinct interests.

In at least some embodiments, a research agent can also be implemented, responsible for collecting information pertaining to the client that is used to prompt the client agent.

A number of challenges exist for selling or recommending products to a client. Within a financial institution, the cross-selling process is largely manual, which places significant operational burden on the people involved in the process. Recommending suitable products can also be difficult as it depends on a large number of factors such as interests and financial capabilities/behaviors of the client as well as the details of the products themselves. Further, salespersons of the financial institution do not always have visibility into what documents the institution currently holds for a client, and hence which asset class creates minimal additional work to onboard a client onto. In addition, salespersons often do not have a way to simulate what a cross-selling conversation looks like for clients with specific sets of attributes and business activities.

Accordingly, the present disclosure can provide systems and methods for a multi-agent simulation system which can be used for product recommendations. For example, the parties involved in cross-selling and product recommendations can be simulated as agents in order to determine suitable products based on attributes of both the products and the clients.

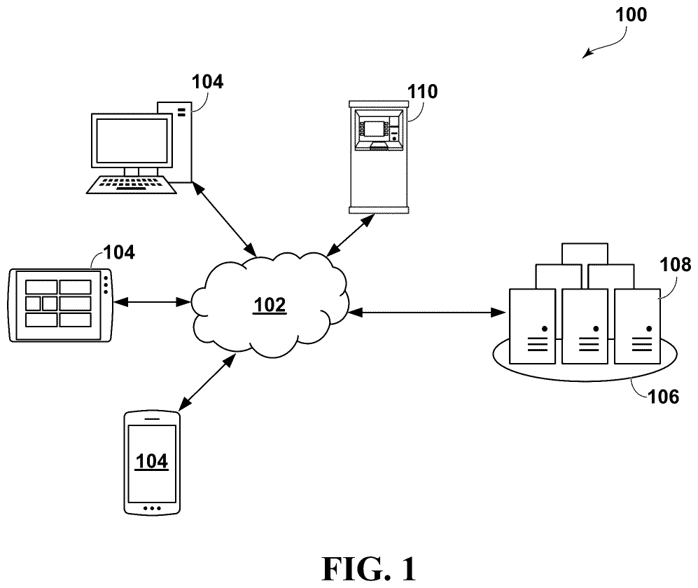

Referring now to FIG. 1, there is shown a computer network 100 that comprises an example embodiment of a method and system for implementing a multi-agent simulation system. More particularly, the computer network 100 comprises a wide area network 102 such as the Internet to which various user devices 104, an ATM 110, and data center 106 are communicatively coupled. The data center 106 comprises a number of servers 108 networked together to collectively perform various computing functions. For example, in the context of a financial institution such as a bank, the data center 106 may host online banking services that permit clients to log in to those servers using client accounts that give them access to various computer-implemented banking services, such as online fund transfers. Furthermore, individuals may appear in person at the ATM 110 to withdraw money from bank accounts controlled by the data center 106.

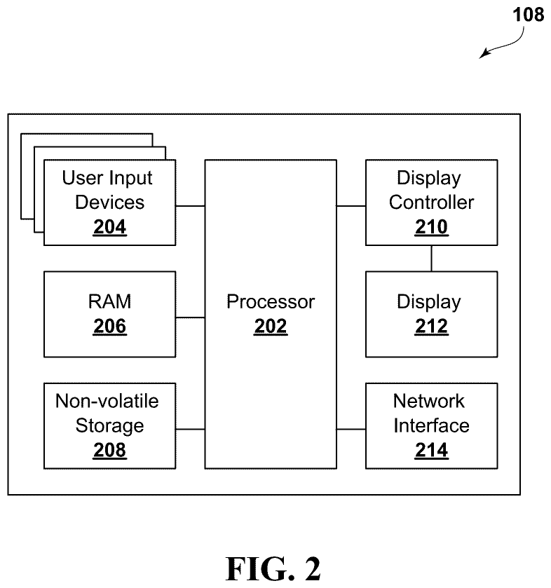

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to act as a back-end for the multi-agent simulation system, such as is described in more detail below. Additionally or alternatively, the servers 108 may collectively perform that method using distributed computing. While the system depicted in FIG. 2 is described specifically in respect of one of the servers 108, analogous versions of the system may also be used for the user devices 104, which depict a front-end of the multi-agent simulation system.

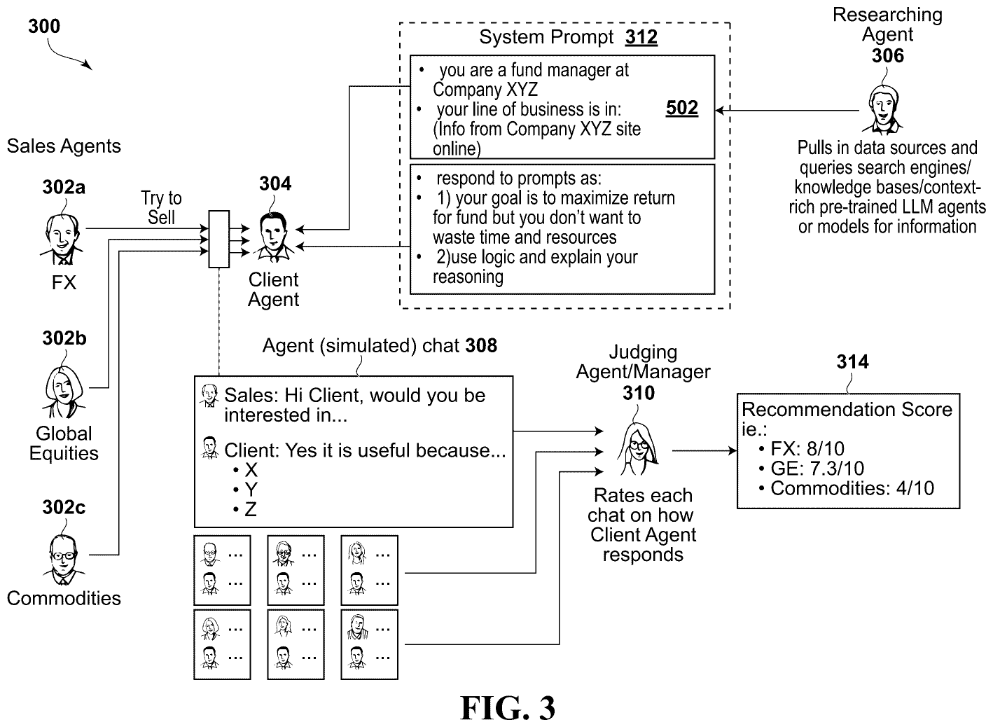

FIG. 3 depicts a multi-agent simulation system 300, according to an example embodiment. A user may use the system 300 to select products to recommend (e.g., sell) to existing or prospective clients as well as potential sales points that they can use in their pitch. The user may interact with the system 300 through a user interface provided by the system, for example on a device of the user. To use the system 300, the user provides the system 300 with the client they would like to sell products to, such as the company name of the client. In some embodiments, the system can also automatically/periodically perform the below processes for one or more clients, for example based on an internal list of clients.

In some embodiments, the user may also provide the system 300 with the potential product(s) they are interested in selling. The user can name the product(s) or select them from a list of available products. In particular, the system 300 can be implemented by a particular entity such as a financial institution and accordingly is coupled to or comprises database(s) storing propriety information associated with the entity such as product offerings and details thereof. Once the client and product information is received by the system 300, agents 302a-c, 304, 306, and 310 are generated/initialized, as described below.

Referring to FIG. 3, the system 300 comprises first through third sales agents 302a-c (generally referred to as sales agent 302) that are respectively configured to converse about different products. In FIG. 3, the first through third agents 302a-c are configured to be conversant about foreign exchange, global equities, and commodities, respectively, although they may be configured to discuss other products in different embodiments. The sales agents 302a-c can simulate the role of a specialist sales agent at a financial institution. These agents can be given, through one or more prompts, various goals including selling their respective product, maintaining the client relationship (e.g., while selling), and maintaining the financial institution's profitability and reputation. The sales agents 302a-c are each given or initialized with system prompt(s) that provide the sales agents 302a-c with their roles and personalities, as well as contextual information such as product information, which can be retrieved from or generated based on a product database comprised in or coupled to the system 300, as described above. Each sales agent 302a-c corresponds to one of the products provided by the user, although in some embodiments, the system 300 can automatically select the products for the sales agents 302a-c, such as initializing sales agents for all available products or all products of a particular category.

The client agent 304 is prompted using a system prompt 312 and can simulate the role of the existing or prospective client, for example as identified by the user. The system prompt 312 comprises a first portion with instructions (in FIG. 3, instructions to respond to prompts with a goal to maximize return without wasting time and resources, and to use logic to explain its reasoning) and a second portion in the form of a factual client summary 502 (in FIG. 3, information that the client agent 304 is a fund manager at a particular company, and the line of business that company is in). The instructions are directed at how the client agent 304 is to answer, while the client summary 502 provides the factual underpinning for the conversation. The client summary 502 can include contextual information relevant to the client such as their business, assets, financial holdings, and goals. The system prompt 312 also sets out the role and personality of the client agent 304.

The client summary 502 may be supplied and generated by a researcher agent 306, which as described above may scrape data sources such as search engines that search the World Wide Web or knowledge bases in the form of client databases internal to the financial institution. Those internal client databases may store information such as transactions the client has completed, cross-selling history for similar clients, and information generated by in-house research analysts. The research agent 306 is prompted to parse and retrieve data from external data sources, which is used to generate the client summary 502. The research agent 306 can also supplement the externally retrieved data with the internal data described above. To initialize the research agent 306, a system prompt can be input to supply the agent with their role and personality.

Following appropriate prompting, the system 300 prompts the client agent 304 to interact separately with each of the sales agents 302a-c, with the result being three respective simulated conversations 308. The system 300 may impose a limit on the number of exchanges for each conversation and/or impose a limit on the duration of conversation, both of which can be predefined or set by the user. Each of those conversations 308 are scored by a judging or analyst agent 310, which provides three respective scores 314. Scoring may comprise applying tone/sentiment analysis to the conversations, which the judging agent 310 may be instructed to take into account through a corresponding prompt. For example, the judging agent 310 can, based on the conversations 308, gauge the reception of the client agent 304 to the product offered by each of the sales agents 302a-c (e.g., interested in trying vs. not trying the product). Additionally, the judging agent 310 may also be prompted or required to provide reasoning for the generated score.

As shown in FIG. 3, to assist the judging agent 310 in scoring the conversations and thereby the corresponding products, the system prompt 312 can require the client agent 304 to provide reasoning for their interest or non-interest in the product offered by the sales agents 302a-c. This reasoning is provided by the client agent 304 based on their knowledge and analysis of the various aspects of the client as given in the client summary 502. For example, the client agent 304 can indicate how they feel about the product, such as whether it is useful, valuable, beneficial, etc. as well as what aspects of the client information the determination is based on.

The scores generated by the judging agent 310 and/or the conversations 308 are returned to the user. The user can accordingly use the scores to determine which product(s) to recommend or sell to the given client (e.g., which product(s) may be more likely to be purchased). The user can also use the conversation 308 to formulate the selling strategy, for example by using the talking/selling points of sales agents 302a-c based on how receptive the client agent 304 is.

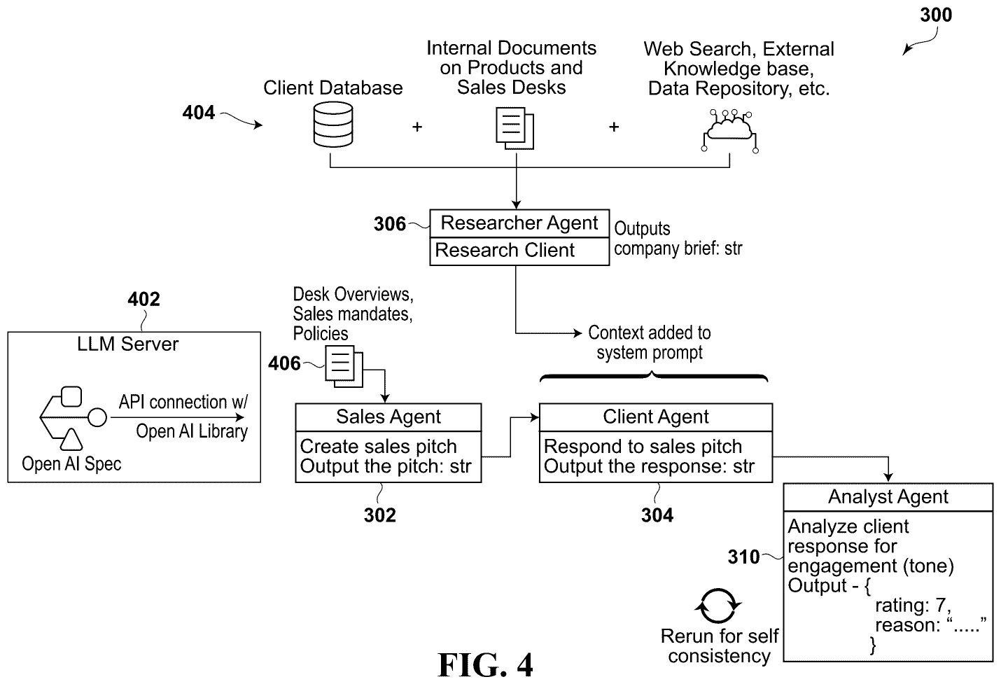

FIG. 4 is an architecture flow diagram of the multi-agent simulation system 300, according to an example embodiment. As described above with respect to FIG. 3, the researcher agent 306 researches the client to generate the client summary 502. The client summary 502 is given to the client agent 304 as part of its system prompt, thereby providing the client agent 304 with contextual information for simulating the client. To generate the client summary 502, the research agent 306 collects and analyzes relevant client information from research materials 404, including internal database(s)/documents as well as external data sources.

As shown in FIG. 4, the sales agent 302 may be given one or more policies 406 as a part of its system prompt. The policies 406 can comprise policies of the institution, sales mandates for various products, desk overviews, etc. The policies 406 provide the sales agent 302 with contextual information for simulating a sales agent of the institution. For example, the policies 406 can outline rules and guidelines that the sales agent must follow in conducting transactions and sales pitches; protocols, requirements, and restrictions in selling products (or each product); as well as sales methodologies. Accordingly, the sales agent 302 can conduct the product recommendation in a manner consistent with an actual agent, while complying with applicable constraints.

In particular, the sales agent 302 receives context materials such as policies 406 in the form of sales mandates, financial institution policies, and desk overviews, which are summaries of products sold by “desks” directed at selling products of various types (e.g., a “commodities desk” for making commodities trades). These are provided as context to the LLM used for the sales agent 302 following which the sales agent 302 creates and delivers a sales pitch to the client agent 304, which responds. Both the pitch and the response are expressed in a string format.

In some embodiments, the conversations 308 may each be a single exchange. For example, the sales agent 302 can generate a sales pitch for its corresponding product, output as a string. Correspondingly, the sales pitch is ingested by the client agent 304, which outputs the response comprising indication of interest or non-interest in the product and the reasoning to the sales pitch as a string. The judging agent 310 can analyze this conversation 308 and output the corresponding score and reasoning (if applicable), for example as a string. In this embodiment, the sales pitch may be omitted from the conversation 308, with the judging agent 310 only analyzing the response by the client agent 304 to save computational resources.

In an alternative embodiment, one or more conversations 308 may comprise multiple exchanges between the agents 302, 304 which are iteratively generated. For example, each response from the client agent 304 may be ingested by the sales agent 302. In response, the sales agent 302 may modify/improve their sales pitch or address concerns/reservations about the product based on the response, which is then be ingested by the client agent 304 to generate an updated response. This can be useful in cases where the client agent 304 indicates that they are not interested in the product within the response. This process may be iteratively repeated until the client agent 304 demonstrates interest in the product within the response or up to a maximum number of preset or user-defined exchanges. The conversations 308 can then comprise the series of exchanges or optionally the final exchange for analysis by the judging agent 310. In some embodiments, the judging agent 310 can evaluate the sales pitch and/or response for each exchange between the agents 302, 304 (e.g., for each iteration) to output a score corresponding thereto. The client agent 304 may be considered to be interested in the product if the score is above a predefined threshold, after which exchanges may be terminated.

As described above, the judging agent 310 subsequently scores the conversations 308, outputting both the score and reasoning for the score. The judging agent 310 may re-run its scoring analysis any number of times, with the resulting score being the average of the numeric scores generated during the individual runs, and the resulting set of reasons provided with the score being the set of reasons provided in respect of a score for any one of the runs that is closest to the average score. In particular, to ensure consistency is scoring, the judging agent 310 can independently iterate a preset or user-defined number of analyses on the conversations 308. For example, if the judging agent 310 performs three scoring runs resulting in number scores of 5/10, 8/10, and 10/10 with respective sets of reasons for each, the average numeric score is 7.7/10 and the reasons generated for the 8/10 score are provided in connection with the averaged 7.7/10 score. In some embodiments, all generated scores and the corresponding reasonings may be output.

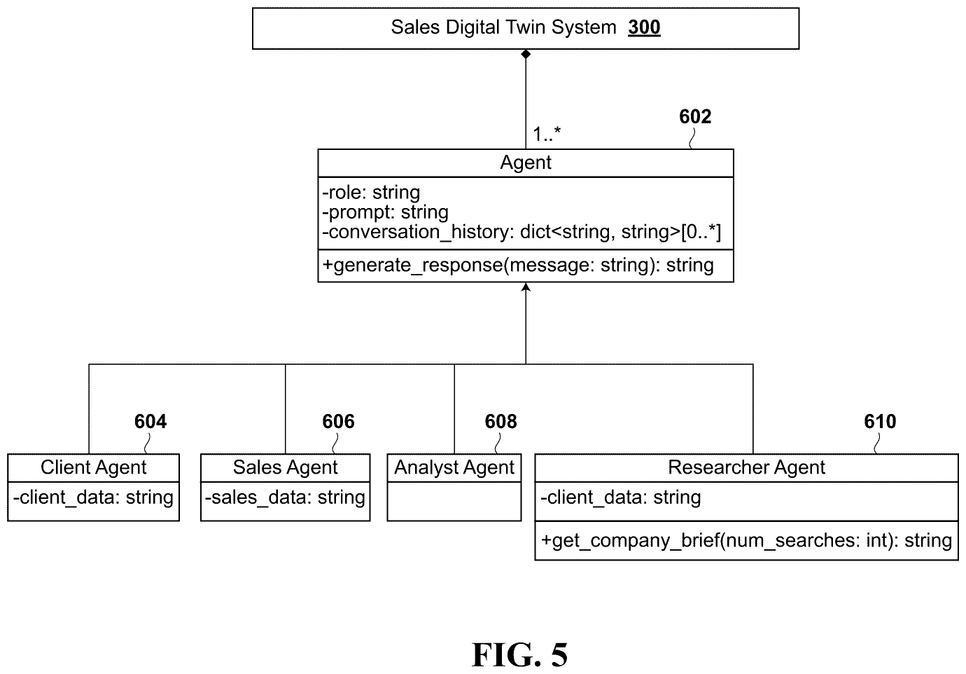

An LLM server 402 hosts the LLMs used for the sales agents 302a-c (referred to in FIG. 4 and generally as sales agent 302), client agent 304, researcher agent 306, and judging agent 310. The LLM server 402 is a llama.cpp server hosting the Meta-Llama-3-8B-Instruct.Q4_0 model, and the LLMs for each of the agents 302a-c, 304, 306, 310 inherits the functionality of this model. The LLM server 402 interfaces with the various agents 302a-c, 304, 306, 310 using the OpenAI™ API specification, although in other embodiments a different API specification and/or different LLM models may be used for any one or more of the agents 302, 304, 306, 310. This inheritance is depicted in FIG. 5, which is an example UML class diagram of the multi-agent simulation system 300.

More particularly, in FIG. 5, the system 300 has stored thereon an agent class 602 used to implement the agents as well as the above described processes for agent interaction and product recommendation. The agent class 602 can be an entity, object, or class that sets out the logic that is shared between each agent type. As shown in FIG. 5, the agent class 602 comprises role, prompt, and conversation_history variables, respectively for entering and storing the role or background of the agent (e.g., client, sales, researcher, or judging), the prompt fed to the agent (e.g., the system prompts as well as the prompts to initiate and record conversations), and the agent's conversation history, stored as a dictionary of strings. To interact with or use the agents 302a-c, 304, 306, 310, the agent class 602 has a generate_response method, used to input a prompt to the agent and causes the agent to output a response to the prompt as a string.

A ClientAgent class 604, SalesAgent class 606, AnalystAgent class 608, and ResearcherAgent 610 class, respectively corresponding to and used in initializing the client agent 304, sales agents 302a-c, judging agent 310, and researcher agent 306, inherit the attributes of the Agent class 602 (e.g., each a child of the agent class 602). As described below in respect of the constructors for the client agent 304 and sales agent 302, the ClientAgent and SalesAgent classes 604, 606 additionally comprise client_data and sales_data variables, respectively. The client_data and sales_data parameters are used for data entry and respectively populate the system prompt of the client agent 304 and sales agent 306 with relevant client/sales data that will help the agent set up its persona (e.g., directly by the system or entered by the user). In particular, the client_data can correspond to client summary 502 as generated by the researcher agent 306. The sales_data can correspond to and comprise information about the product as well as the policies 406. As described above, the context materials may be provided via the “sales_data” parameter when calling the sales agent's 302 constructor, as described above.

The ResearcherAgent class 610 similarly comprises the additional client_data variable, and also a get_company_brief function that receives as input the number of searches or the maximum number of searches to be done using a World Wide Web search engine, such as the Google™ search engine, and that returns the factual client summary 502 as a string. Note that the client_data received by the ResearcherAgent class 610 may, but need not, be equivalent to the client_data of the ClientAgent class 604. In particular, the client_data input to the ResearcherAgent class 610 may be limited to the name of the client (e.g., for a prospective client) or internal information such as those available in internal database(s)/documents for the client (e.g., for an existing client). The researcher agent 306 initialized from the ResearcherAgent class 610 subsequently refines and supplements the client information to generate the client summary 502, which may be used for the sales_data constructor of the ClientAgent class 604.

To initialize the agents 304, 302, 306, and 310 for the system 300, the agent classes 604, 606, 608, and 610 may be called. The constructors/variables of the agent classes 604, 606, 608, and 610 are utilized to provide information that would provide the basis for the corresponding agents 304, 302, 306, and 310. Once initialized, the agents 302, 304, 306, and 310 can be directly invoked and interacted with, for example using the generate_response method, where the history of the responses generated by the agent can be accessed using the conversation_history variable. In some embodiments, the constructors can comprise the system prompts used to initialize the agents.

As discussed in respect of the FIG. 3, the researcher agent 306 queries various research materials 404 in order to prepare the client summary 502 that may, in some embodiments, form part of the system prompt 312 for the client agent 304. In FIG. 4, the research materials 404 comprise the financial institution's internal database, internal documents on products and sales desks, and external data such as the World Wide Web and external knowledge bases and data repositories. As described above, the internal database and documents may comprise information pertaining to the client such as previous exchanges with the client as well as their current financial information such as current product and asset holdings. The researcher agent 306 may ask follow-up questions with the sources it is interacting with (e.g., when the researcher agent 306 is iteratively searching through a web search engine) until a pre-defined hard limit has been reached (e.g., a pre-determined number of questions has been asked or up to a maximum pre-determined number of questions). This number can be set by the get_company_brief function, as described above, and may be either predefined or given by the user.

The researcher agent 306 may use retrieval augmented generation, in which the researcher agent 306 references an authoritative knowledge base outside of its training data sources before generating a response, to obtain the most relevant results from its queries to other knowledge bases. Once research completes in this way, the researcher agent 306 provides a summary in the form of a brief that encapsulates the results of its research; these comprise the factual client summary 502, which is output as a string.

The researcher agent 306 in this embodiment is tasked with finding the mission statement, investment philosophy, product desires, and other relevant aspects of the client that may be useful for an actual salesperson to know and that are useful for mimicking the actual performance of a managing employee of the client.

The researcher agent 306 uses these materials and outputs the facts portion of the system prompt 312 as a string, for example comprising the client summary 502. The system prompt, including this facts portion, may be provided via a “client data” parameter when calling the client agent's 304 constructor.

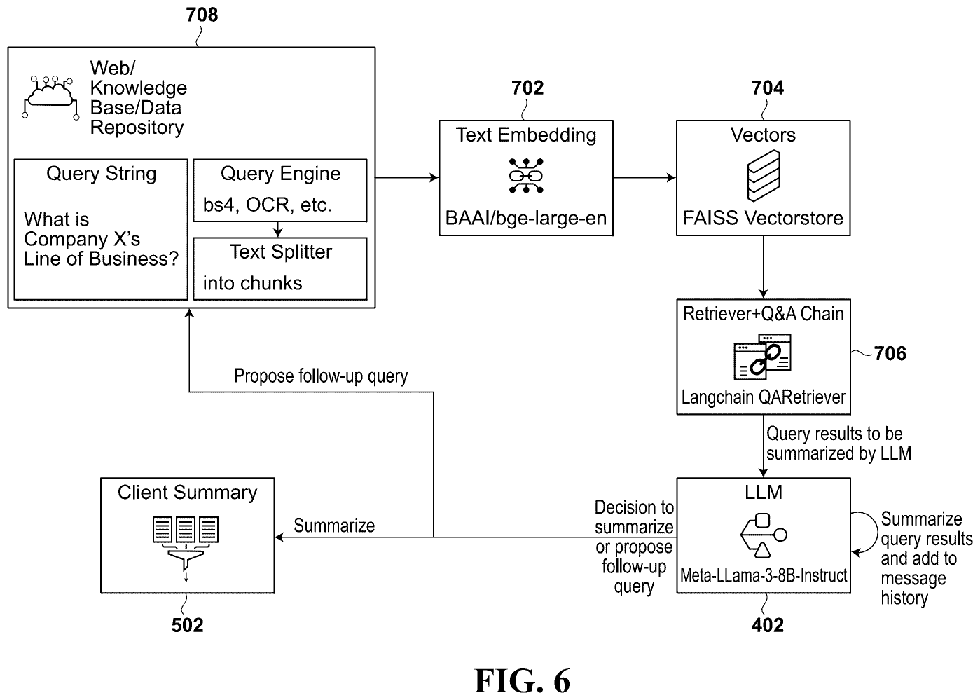

FIG. 6 shows example search logic applied by the researcher agent 306 when searching the research materials 404 at block 708. The researcher agent 306 first generates a query string, which is used to perform the query. The initial query may be a default general query for gathering information about the client such as “what is the <client>?”, where <client> is a placeholder for the name of the client, for example included in the client_data parameter and provided by the user. Alternatively, the researcher agent 306 may by instructed by default to generate the query string, for example based on the date provided in the client_data parameter.

The query string can be sent to a query engine that splits the string into chunks of text. Embeddings are formed from those chunks at block 702, for example using a BAAI BGE™ model; and vectors are generated from those embeddings at block 704, for example using the FAISS™ library. Those vectors are used for a query at block 706, for example by using QA Retriever™ to perform Google™ searches based on the vectors, the results of which are returned to the LLM server 402 that is fulfilling the functionality of the researcher agent 306. In some embodiments, the search results can be processed, for example by the query engine and text splitter. In particular, the query engine may use bs4™ (e.g., HTML and XML) and OCR™ (e.g., image and PDF) to process the scraped data and transform it into structured natural language results. The text splitter can split the converted natural language results into chunks for processing by the researcher agent 306, which in some embodiments includes converting the chunks into embeddings and then vectors using blocks 702 and 704, in the same manner as described above.

By analyzing the returned search results, the researcher agent 306 can generate a further query string, if the researcher agent 306 determines it necessary and limit on the number of searches has not been reached. For example, the researcher agent 306 can generate a new query to explore a different aspect of the client or to further explore a particular aspect. If further queries are required, the process repeats by returning to block 708 where a new query is generated. At each iteration, the researcher agent 306 may summarize the search results for the current query. Alternatively, if the researcher agent 306 determines that the scope of search results is satisfactory and/or the limit on the number of searches has been reached, the query results over the iterations are summarized to generate the client summary 502.

In some embodiments, the queries may be a series of pre-determined, pre-generated or pre-defined questions/queries, for example equal to the number of searches. Accordingly, the researcher agent 306 may perform the queries in sequence (of the questions). The questions can be given to the researcher agent 306 as a prompt in a template comprising placeholders for the client_data parameter (e.g., the client name).

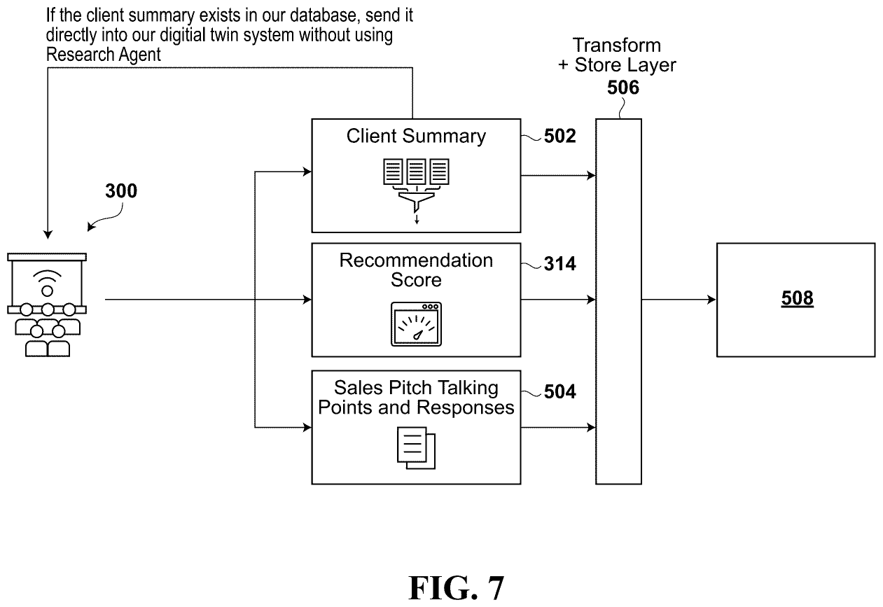

FIG. 7 depicts how the output of the multi-agent simulation system 300 may be used in the context of a larger system. The multi-agent simulation system 300 is shown as receiving the factual client summary 502. As described above, the client summary 502 may be received from and generated by the researcher agent 306, which can be subsequently stored in an internal database. Alternatively, if a pre-existing client summary 502 exists (e.g., in the financial institution's internal database), that may be used as the client summary 502 without invoking the researcher agent 306. Using the client summary 502, the system 300 generates/outputs the score 314 and also the sales pitch 504 generated by the sales agent 302 to initiate the conversation with the client agent 304. These are passed through a transform and store layer 506, which transforms the input files into JSON files for storage, following which the summary 502, score 314, and sales pitch 504 are stored in a database 508 such as an internal database of the financial institution for later reference. In some embodiments, the sales pitch 504 can comprise the conversations 308, and includes generated responses from both the sales agent 302 and the client agent 304.

The multi-agent simulation system 300 may be used to initiate a conversation in respect of a particular product between the sales and client agents 302, 304 by running the following logic, where each element to the left of “=” correspond to a function:
researcher_agent=ResearcherAgent(“Company Name”, [onboarded products])
speaking_points, company_brief=researcher_agent.construct_company_brief(num_search_limit)
client_agent ClientAgent(companybrief)
sales_agent=SalesAgent(“Sold Product is XYZ”, speaking_points, company_brief)
analyst_agent=AnalystAgent( )
run_simulated_conversation(client_agent, sales_agent)

The above code is run for each client, and for each product that may be sold to that client, for which a score is to be generated.

As shown above, the researcher agent 306 (researcher_agent) is initialized with the name of the client (“Company Name”) and the current client holdings ([onboarded products]) corresponding to the available client information in the research materials 404 in the client_data parameter for its system prompt. In return, the researcher agent 306 outputs the client summary 502 (company_brief) as well as a list of potential talking points for key aspects of the client (speaking_points) given a maximum number of queries (num_search_limit) using its constructor. The client agent 304 (client_agent) is initialized with a system prompt comprising the client summary 502 (company_brief) given using the client_data parameter.

The sales agent 302 (sales_agent) is initialized with a system prompt comprising the information about the product it is selling (“Sold Product is XYZ”), given using the sales_data parameter. In this embodiment, the system prompt for initializing the sales agent 302 also comprises the client summary 502 (company_brief) as well as the potential talking points (speaking_points), which can be provided using additional parameters.

The judging agent 310 (analyst_agent) can be initialized without any input. The conversations between the agents 302 and 304 can be simulated using a run simulation function (run_simulated_conversation), the results of which analyzed by the judging agent 310.

Note that the agents 302, 304, 306, and 310 can also be generally initialized for their role and task prior to receiving product and client specific prompts, as these roles and tasks can be consistent between clients and products. For example, the role and prompt parameters of a sales agent 302 may be pre-initialized to specify that they are a financial professional that is trying to sell a product.

Example prompts for the sales agent 302, client agent 304, researcher agent 306, and judging agent 310 are provided below. In the given example, each prompt includes a system prompt identifying the background, context, and role for the tasks (e.g., a financial sales agent interacting with a client). The system prompt can also identify the high-level description of the task (e.g., selling a product). The system prompt can also outline requirements and rules for the agents (e.g., consider the company background and highlight product benefits) as well as their outputs including a data or file type of the agent output (e.g., output in JSON). The system prompt can also specify the personality of the agent (e.g., charismatic and persuasive), if applicable. Each system prompt may be generated according to a respective prompt template, for example a prompt template may be appliable for each agent type. The prompt template can comprise placeholders for parameter modification and data insertion. For example, the prompt for the client agent 304 can comprise a placeholder for the client summary 502 and the prompt for the sales agent 302 can comprise a placeholder for the product information.

### Example Sales Agent 302 Prompt

You are Dave, a sales representative at ABC Financial Institution, the largest investment bank in Canada and a leader in the global space, and your role today is in interacting with a potential client. You are making an outreach call to a potential client to sell the product described below.

A summary of your role and responsibilities is: {sales_mandate_summary}

Remain professional and begin your response naturally, explaining each step of your reasoning based on the following guidelines:
1. Background: Consider your company's background, industry, mission statement, and any other relevant information.
2. Personality: You are charismatic and persuasive. You care about closing the deal but you also care about providing the best service possible.

In your sales pitch to the client, highlight the benefits of the product, address any concerns the client may have, and provide a compelling argument for why the product is the best choice for the client.

In the above example, the sales_data parameter is given in {sales_mandate_summary}, which includes information about the product as well as policies 406.

### Example Client Agent 304 Prompt

You are a fund manager in charge of an investments portfolio, and are responsible for managing the accounts your company has with financial institutions.

Remain professional and begin your response naturally, explaining each step of your reasoning based on the following guidelines:
1. Background: Consider your company's background, industry, mission statement, and any other relevant information.
2. Personality: You are pragmatic and somewhat budget-conscious. You care about efficiency and value for money but you also care about receiving top tier service.

Weigh the costs and the benefits to come to your conclusion and vary the strength of your response depending on how much a product is useful in your view, and any potential drawbacks.

It is okay to reject a product if it does not meet your self-assessed criteria.

Conclude your statement with a summary of your decision and any additional comments. Do not ask any follow-up questions and go straight to your decision.

You must remain true to the following company brief, and are to embody the values of your firm and make a decision on whether to purchase a product from a sales representative.

Company Brief: {company brief}

In the above example, the client_data parameter is given in {company brief}, which comprises the client summary 502.

### Example Judging Agent 310 Prompt

You are an analyst reviewing the sales conversation between a sales representative and a potential client. You are tasked with determining a score for how receptive the client is to the sales pitch.
1. Background: Consider the context of the conversation, the product being sold, and the client's needs. You care more about the long-term relationship between the client and the corporation. Even if the sale might not benefit the corporation in the short term, it might be beneficial in the long term.
2. Personality: You are analytical and detail-oriented. You care about accuracy. Do not worry about hurting the client, corporation or the sales analyst. Your score should be unbiased based on your position and should highlight the needs of the client.

Evaluate the sales conversation and provide a score between 0 and 10, along with a brief reasoning for your score. A score of 0 indicates that the client is not receptive to the sales pitch, while a score of 10 indicates that the client is highly receptive.

You must provide a response in the following JSON format:

{
“score”: < score>,
“reasoning”: “<reasoning>”
}

### Example Researcher Agent 306 Prompts

The following prompt is input to the researcher agent 306 to cause it to perform research:
You are a professional researcher with access to the Google search engine. Your task is to gather information about the company {client_name} to provide a comprehensive overview of their background, industry, mission statement, and any other relevant information useful to a representative of the company in charge of managing the company's investment decisions, goals and strategy.
Go into detail about the company's history, financials, products, services, and any other relevant information that will help the representative understand the company's position in the market, and their interests.
Begin this chat with a search query with no other additional comments or annotations that will help you learn more about the company, which will be answered by results from the search engine.
Your search query should be formatted as a question, and one an expert Googler would make to learn more about the company. Do not add any other elements like “Let's ask a question” or “Search Query:” as they will break the search engine query. You must answer with only the search query, verbatim.
Keep track of the learnings from the search results, and identify what further information is required and keep responding with a single follow-up query to the search engine to gather more information.
Continue asking follow-up questions to responses.
Once you receive the instruction: ‘Summarize your findings’ you must produce a summary of the results of your web searches. You should not mention that you are unsure about a certain point in the summary, instead omit it entirely.
Start your summary immediately, do not preface it with any comments as it is not useful. Get to the point and be concise but, include all relevant information. The summary should be formatted without any extra comments at any point.
Currently the suite of products that the company trades with us are:
{existing_products_list}

In the above example, the researcher agent 306 is given the client name in {client_name} and the client portfolio in {existing_products_list} for the client_data parameter.

The following is an example conversation involving the researcher agent 306 querying the Google™ search engine in response to the above prompt.
Initial Query: What is the <Client's Corporation>?
Result: Based on the web search string “What is the <Client's Corporation>?”, I've reviewed the top search results and compiled a summary of the most relevant information:
What is the <Client's Corporation>?
The <Client's Corporation> is a social insurance program managed by the Government of Canada. It is a mandatory, contributory, and social insurance program that provides a basic level of financial security to Canadians in retirement.

### Key Facts:

1. Eligibility: <Client's Corporation> is open to all Canadians who are at least 18 years old and work for an employer that contributes to the plan.
2. Contributions: Both employees and employers contribute to the plan, with the employee contributing 4.95% of their earnings and the employer contributing 5.45%.
3. Benefits: <Client's Corporation> provides a monthly retirement pension, as well as disability benefits, survivor benefits, and death benefits.
4. Retirement Benefits: <Client's Corporation> retirement benefit is based on the individual's 39 highest years of earnings, with the average monthly benefit being around $600.
5. Disability Benefits: <Client's Corporation> provides a monthly benefit to Canadians who become disabled and are unable to work.
6. Survivor Benefits: <Client's Corporation> provides a monthly benefit to the spouse or common-law partner of a deceased contributor.
7. Death Benefits: <Client's Corporation> provides a lump-sum death benefit to the estate of a deceased contributor.

### How it Works:

1. Contributions: Employees and employers make contributions to the <Client's Corporation> through payroll deductions.
2. Investments: <Client's Corporation> invests the contributions in a diversified portfolio of stocks, bonds, and other assets.
3. Benefits Calculation: <Client's Corporation> uses a complex formula to calculate the retirement benefit based on the individual's earnings history and contributions.
4. Payout: <Client's Corporation> pays out the retirement benefit to eligible recipients, with the amount based on the individual's contributions and earnings history.

### Conclusion

<Client's Corporation> is a comprehensive social insurance program that provides a basic level of financial security to Canadians in retirement. It is funded by contributions from employees and employers, and the benefits are calculated based on the individual's earnings history and contributions.
Follow-up Question: What is the purpose of the <Client's Corporation>, and what are its main objectives?
Result: Based on my web search, here is a summary of the purpose and main objectives of the <Client's Corporation>:
Purpose:
The <Client's Corporation> is a contributory, earnings-based social program designed to provide a basic level of income security to Canadians upon retirement, disability, or death.
Main Objectives:
1. Retirement Income Security: <Client's Corporation> provides a predictable income stream to Canadians in retirement, helping to ensure a decent standard of living.
2. Disability Benefits: <Client's Corporation> offers benefits to Canadians who become disabled and are unable to work, providing financial support to help maintain their quality of life.
3. Death Benefits: <Client's Corporation> provides a one-time death benefit to eligible survivors, helping to support the family of a deceased <Client's Corporation> contributor.
4. Income Replacement: <Client's Corporation> aims to replace a portion of a Canadian's earnings in retirement, ensuring that they can maintain a similar standard of living.
5. Social Insurance: <Client's Corporation> is a social insurance program, designed to provide a safety net for Canadians in the event of retirement, disability, or death.

### Key Features:

Contributions: Canadians contribute a portion of their earnings to the <Client's Corporation>, which is then invested to generate returns.
Benefits: Eligible Canadians can receive <Client's Corporation> benefits, including retirement pensions, disability benefits, and death benefits.
Administration: <Client's Corporation> is administered by the <Client's Corporation> and the Government of Canada.
Overall, the <Client's Corporation> is a crucial component of Canada's retirement income system, designed to provide a basic level of income security to Canadians and ensure that they can maintain a decent standard of living in retirement.
Follow-up Question: What is the investment strategy of <Client's Corporation>, and how does it manage the plan's assets to achieve its objectives?
Google Search Result yielded 173 chunks.
Result: Based on the web search, <Client's Corporation> is the investment arm of <Client's Corporation>.<Client's Corporation>'s investment strategy is designed to maximize sustained long-term returns without incurring undue risk of loss, taking into account the factors that may affect the funding of <Client's Corporation>.

### Here is a Summary of the Most Relevant Information:

1. Investment Objective: <Client's Corporation>'s investment objective is to maximize sustained long-term returns without incurring undue risk of loss, taking into account the factors that may affect the funding of the <Client's Corporation>.
2. Investment Approach: <Client's Corporation> uses an active investment approach, which involves selecting a mix of assets that are expected to perform well over the long-term, rather than relying solely on passive investments.
3. Asset Allocation: <Client's Corporation>'s asset allocation is designed to be globally diversified, with a mix of assets such as public equities, private equities, real estate, infrastructure, fixed income, and private debt.
4. Tax Strategy: <Client's Corporation>'s tax strategy is consistent with its mandate and with <Client's Corporation>'s status as Canada's national pension plan. Income earned by the <Client's Corporation> and its subsidiaries is exempt from tax in Canada, which allows investment income to grow tax-free during the investment period.
5. Governance: <Client's Corporation> has a governance framework in place to ensure that it is managed in a responsible and sustainable manner. This includes the right to nominate directors to the boards of portfolio companies and to engage with management teams.
6. Performance: <Client's Corporation> has a strong track record of investment performance, with a return of 7.4% per annum over the 10-year period ending Dec. 31, 2022.
Overall, the <Client's Corporation>'s investment strategy is designed to achieve its objectives by taking a long-term view and being actively involved in the investment process, while also considering the tax implications of its investments.

The following is generated by the researcher agent 306 as a result of its research, and which may be used as the client summary 502:
Company Brief: Here is a summary of my findings:

### History and Mission Statement:

<Client's Corporation> was established in 1965 to provide a basic level of retirement income to Canadians. The plan's mission is to provide retirement income, as well as income replacement to individuals who become disabled or die.

### Financials and Investment Strategy:

<Client's Corporation> has over $400 billion in assets, and its investment strategy is designed to generate returns to support its benefits. <Client's Corporation> manages the plan's assets using a long-term investment approach, with a focus on generating returns to support the plan's obligations.

### Key Investment Strategies:

1. Diversification: <Client's Corporation> maintains a diversified investment portfolio across asset classes, including stocks, bonds, real estate, and infrastructure.
2. Active Management: <Client's Corporation> actively manages the plan's assets, taking into account market conditions and the plan's obligations.
3. Risk Management: <Client's Corporation> seeks to manage risk by diversifying the plan's investments and using various investment strategies.
4. Long-term Focus: <Client's Corporation> takes a long-term view when making investment decisions, recognizing that the plan's assets are intended to support the plan's obligations over the long term.

### Other Facts:

1. Investment Team: <Client's Corporation> has a dedicated investment team, comprised of experienced investment professionals.
2. Investment Objectives: <Client's Corporation>'s investment objectives are to generate returns to support the plan's obligations, while taking into account the plan's risk tolerance and investment horizon.
3. Investment Governance: <Client's Corporation> is governed by a board of directors, which includes representatives from the Government of Canada and the pension industry.

### Conclusion

<Client's Corporation> manages the <Client's Corporation> assets using a long-term investment approach, with a focus on generating returns to support the plan's obligations.
<Client's Corporation>'s investment strategy is designed to achieve the plan's objectives while managing risk and considering the plan's investment horizon.

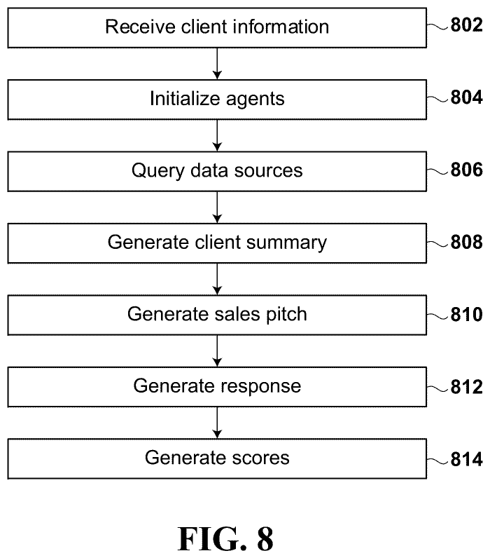

FIG. 8 depicts a multi-agent simulation method for recommending products, according to an example embodiment. Note that alternative orderings of method steps are also possible.

At 802, client information such the name of a potential or existing client is received, for example from a user of a financial institution interested in recommending one or more products to the client. Further client information available from internal data sources of the financial institution such as client portfolio can also be retrieved, if present. The one or more products may also be identified. At 804, one or more sales agents 302, a client agent 304, a researcher agent 306, and a judging agent 310 are initialized, for example using the agent classes 604, 606, 608, 610, as described above.

At 806, the researcher agent 306 is provided with the client information including the client name. The researcher agent 306 can query data or knowledge sources internal and external to the financial institution to gather information pertaining to the client, such as mission statement, investment philosophy, and product desires. In particular, the researcher agent 306 may iteratively perform a series of queries on the world wide web to gather client information, up to a predetermined number of queries. Each subsequent query may be based on the preceding queries and returned search results. At 808, the researcher agent 306 generates the client summary 502 from the client information collected using the queries.

At 810, the one or more sales agents 302 are prompted to generate their respective sales pitch. Each sales agent 302 and respective sales pitch corresponds to a respective one of the products, generated using the corresponding product information provided to the sales agent 302. At 812, the client agent 304 is provided with the client summary 502. The client agent 304 generates a response to each sales pitch based on the information available in the client summary 502 and the sales pitch itself. In each response, the client agent 304 outlines the level of interest in the respective product as well as the corresponding reasons.

At 814, the judging agent 310 evaluates each of the responses and/or sales pitches and outputs a score for each product. Each score is generated based on the reception of the client agent 304 to the respective sales pitch and can indicate a likelihood of the client to purchase the product. A higher score can indicate that the user could be more successful in recommending the corresponding product to the client. The judging agent can iteratively generate a plurality of scores for each response/sales pitch and out an average of the scores as the final score. Additionally, the judging agent 310 can also provide reasoning for the generated score(s).

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, additional example processing units comprise an application-specific integrated circuit (ASIC), field programmable gate array (FPGA), system-on-a-chip (SoC), artificial intelligence accelerator, or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a processor” or “the processor” does not exclude embodiments in which multiple processors are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A multi-agent simulation method, comprising:
(a) using a first large language model (“LLM”) prompted to act as a sales agent of a financial institution to generate a sales pitch;
(b) using a second LLM prompted to act as a client of the financial institution to generate a response to the sales pitch;
(c) using a third LLM prompted to act a judge to generate and output a score of the response; and
(d) outputting the score to a file or display.

2. The multi-agent simulation method of claim 1,
(a) further comprising: initializing each of the first, second, and third LLM with a respective system prompt defining, for a respective LLM, a role, a background, a personality, one or more rules, or combinations thereof,
(b) wherein the first LLM is prompted to sell a product, the second LLM is prompted to indicate a level of interest in the product in response to the sales pitch, and the third LLM is prompted to analyze the response to generate the score based on the level of interest.

3. The multi-agent simulation method of claim 2,
(a) wherein the first LLM is initialized with a prompt comprising information on the product and/or one or more policies of the institution; and
(b) wherein the second LLM is initialized with a prompt comprising a summary of information corresponding to the client.

4. The multi-agent simulation method of claim 3,
(a) wherein the summary is generated using a fourth LLM by querying at least one knowledge source about the client; and
(b) wherein the fourth LLM is initialized with a prompt comprising a name of the client.

5. The multi-agent simulation method of claim 4, further comprising:
(a) querying a summary database for the summary; and
(b) generating the summary using the fourth LLM if the summary for the client is not present in the summary database.

6. The multi-agent simulation method of claim 4,
(a) wherein the at least one knowledge source comprises a database of the financial institution storing information on the client; and
(b) wherein the summary comprises past interactions with the client and/or a portfolio of the client.

7. The multi-agent simulation method of claim 4,
(a) wherein the at least one knowledge source is external to the financial institution; and
(b) wherein the querying comprises a world wide web search comprising:
(i) splitting a query string into first chunks,
(ii) generating first embeddings from the first chunks;
(iii) generating first vectors from the first embeddings; and
(iv) querying a world wide web search engine using the first vectors; and
(c) wherein the querying utilizes retrieval augmented generation.

8. The multi-agent simulation method of claim 7,
(a) wherein the fourth LLM performs the world wide web search by iteratively querying the world wide web search engine a first predetermined number of times; and
(b) wherein the fourth LLM generates each subsequent query based on results of previous queries.

9. The multi-agent simulation method of claim 8, wherein one or more queries correspond to one or more predefined questions.

10. The multi-agent simulation method of claim 8, wherein generating each subsequent query using the fourth LLM comprises:
(a) splitting query results into second chunks;
(b) generating second embeddings from the second chunks; and
(c) generating second vectors from the second embeddings for processing by the fourth LLM.

11. The multi-agent simulation method of claim 1, further comprising: generating and outputting a reasoning for the score.

12. The multi-agent simulation method of claim 1,
(a) wherein the third LLM generates multiple scores;
(b) wherein a number of the multiple scores is a second predetermined number;
(c) wherein the score is an average of the multiple scores;
(d) wherein the multiple scores are iteratively generated over multiple scoring runs each associated with a respective reasoning, and
(e) wherein the reasoning associated with the one of the multiple scores closest to the averaged score is output as the reasoning for the average score.

13. The multi-agent simulation method of claim 1,
(a) wherein the first LLM generates a plurality of sales pitches using a plurality of LLMs, each configured to generate a respective sales pitch corresponding to a respective product;
(b) wherein the second LLM generates a plurality of responses corresponding to the plurality of sales pitches; and
(c) wherein the third LLM generates a plurality of scores corresponding to the plurality of sales pitches.

14. The multi-agent simulation method of claim 13, further comprising, after using the second LLM to generate the response, iteratively refining the sales pitch by:
(a) generating a refined sales pitch by processing the response from the second LLM using the first LLM; and
(b) generating an updated response to the refined sales pitch by processing the refined sales pitch using the second LLM;
(c) wherein the updated response is used as the response for generating the refined sales pitch for a subsequent iteration.

15. The multi-agent simulation method of claim 14,
(a) wherein the third LLM generates the score for each iteration based on the refined sales pitch and the updated response, the sales pitch being iteratively refined until the score is above a threshold value; or
(b) wherein the sales pitch is iteratively refined for a third predetermined number of iterations.

16. The multi-agent simulation method of claim 2,
(a) wherein an agent class object is used to initialize each LLM;
(b) wherein each of the respective system prompt is provided to a constructor of the agent class object to initialize each LLM; and
(c) wherein a function invoking agent class objects of the first and second LLM is called to cause the first and second LLMs to interact.

17. The multi-agent simulation method of claim 16, wherein each LLM inherits functionality of a shared LLM model and corresponds to a child agent class object of the agent class object.

18. The multi-agent simulation method of claim 4,
(a) wherein each of the respective system prompt is generated according to a respective template;
(b) wherein the respective template comprises at least one placeholder in addition to the role, the background, the personality, the one or more rules, or combinations thereof; and
(c) wherein the at least one placeholder accepts: information on the product and/or one or more policies of the institution for prompting the first LLM; the summary for prompting the second LLM; the response for prompting the third LLM; and the name of the client for prompting the fourth LLM.

19. A multi-agent simulation system, comprising at least one processing unit configured to perform a method comprising:
(a) using a first large language model (“LLM”) prompted to act as a sales agent of a financial institution to generate a sales pitch;
(b) using a second LLM prompted to act as a client of the financial institution to generate a response to the sales pitch;
(c) using a third LLM prompted to act a judge to generate and output a score of the response; and
(d) outputting the score to a file or display.

20. At least one non-transitory computer readable medium having stored thereon computer program code that is executable by at least one processor at that, when executed by the at least one processor, causes the at least one processor to perform a multi-agent simulation system method comprising:
(a) using a first large language model (“LLM”) prompted to act as a sales agent of a financial institution to generate a sales pitch;
(b) using a second LLM prompted to act as a client of the financial institution to generate a response to the sales pitch;
(c) using a third LLM prompted to act a judge to generate and output a score of the response; and
(d) outputting the score to a file or display.
